(19) United States
(12) Patent Application Publication
(10) Pub. No.: US 2009/0289209 A1
(43) Pub. Date: Nov. 26, 2009

(54) Process For Hardfacing of Bore and Seat Face Intersection on Gate Valve

(75) Inventors: David D. Comeaux, Houston, TX (US); Salvador G. Maldonado, The Woodlands, TX (US); Eddie J. Mayea, Iowa Colony, TX (US); Mahesha Udipi, Houston, TX (US)

Correspondence Address: Patent Department;GE Oil & Gas, 4424 West Sam Houston Parkway North, Suite 100, Houston, TX, 77041, US

(73) Assignee: Vecto Gray Inc., Houston, TX (US)

(21) Appl. No.: 12/434,502

(22) Filed: May 1, 2009

Related U.S. Application Data
(60) Provisional application No. 61/049,571, filed on May 1, 2008.
(60) Provisional application No. 61/074,741, filed on Jun. 23, 2008.

(51) Int. Cl. F16K 3/30; B05D 1/02

(52) U.S. Cl. 251/359; 427/421.1

(57) ABSTRACT

A method of treating a valve with a coating, such as hardfacing, that includes depositing the coating with a spray stream that is oriented perpendicular to the surface being treated. The method further includes applying a coating of uniform thickness onto lateral surfaces of a valve seat, a portion of the valve seat bore, and the interface between a valve seat lateral surface and the valve seat bore. The valve seat bore can include an annular recess formed to receive a layer of coating.

### CROSS REFERENCE TO RELATED APPLICATIONS

This application claims priority to and the benefit of co-pending U.S. Provisional Application Ser. No. 61/049,571, filed May 1, 2008, the full disclosure of which is hereby incorporated by reference herein.

### FIELD OF INVENTION

This invention relates in general to gate valves used in the oil and gas industry, and in particular to a process for coating the inner rim of a gate valve seat.

### Description of Related Art

Referring to FIGS. 1 and 2, a standard gate valve 10 as used in the oil and gas production industry according to the prior art is illustrated. Valve 10 has a body 12 with a generally flow passage 14 extending there through. A pair of ring-shaped seats 16 rest in recesses formed in body 12. Seats 16 each have a front face 18 and a back face 19 and contain an annular bore 20. The bore 20 has a wall 22 with an inside diameter that is approximately equal to the flow passage 14 inside diameter. A chamfered edge or curved surface is formed on each seat 16 where the front face 18 joins the inner wall 22. Each seat 16 has an outer rim 25 at the junction of front face 18. A gate 26 is positioned between the seats 16. Gate 26 has a solid portion 28 with a hole 30 shown registering with the bore 20 allowing flow through the valve 10. The hole 30 has an inside diameter that is approximately equal to the inside diameter of the bore 20 in the seats 16.

The gate 26 is movable relative to the front faces 18 of the seats 16. Shown in FIG. 2, the gate 26 has moved with respect to its position in FIG. 1, talking the hole 30 out of registration with the bore 20 to close the valve. When the valve 10 is in the closed position, the gate 26 and the seat front faces 18 are in contact and held closely together to prevent fluid leakage. Over time, as the gate 26 moves repeatedly between the open and closed positions, wear and friction occur at the areas of contact between the solid portion 28 and the front faces 18. These wear surfaces can be treated by applying a coating 32 or “hardfacing,” for example tungsten carbide to the contacting surfaces of at least one of the gate 26 and the seats 16.

Depicted in FIG. 3 is a valve 10 having a coating 32 applied to the seat front face 18 downstream of the gate 26. Damage is most prevalent along the front face 18 and wall 22 boundary because the gate 26 elastically bows into the seat bore 20 under a pressure load. When the gate 26 is moved to open the valve, the deflected portion of the gate 26 applies concentrated forces onto the seat 16 which can result in damage.

Typically, a thermal spray or vapor gas deposition processes have been used to apply the coating 32 to the seat 16. A thermal spray gun 34 according to the prior art is illustrated in FIG. 4 applying a coating to a valve seat 16. A robotic arm 36 is attached to the gun 34 and programmed to direct the movement of the gun 34. A fine metallic powder, for example, a member of the tungsten carbide-cobalt family, is introduced into the barrel of the gun at an entry point 38. Oxygen and fuel gas, for example, propane, propylene, hydrogen, or some hydrocarbon, are fed into the barrel of the gun at entry points 40 and 42. Purge gas may be introduced into the barrel at entry point 46. The fuel gas is ignited, and the resulting hot, high-pressure gas heats the powder and forces it out of the nozzle 44 of the gun barrel as a beam 45 for use as coating 32. The coating 32 may be dispensed through the nozzle 44 in the form of a continuous stream, or alternatively, it may be dispensed in intermittent pulses, with nitrogen gas used to purge the barrel after each pulse.

To apply coating 32 to a valve seat 16, as illustrated in FIGS. 4 and 5, the seat 16 is affixed to a base 48. The robotic arm 36 positions the spray gun 34 so that the nozzle 44 is directed towards the front face 18 of the seat 16. There is preferably a fixed distance between the end of the nozzle 44 and the front face 18 of the seat 16 in order to produce a beam 45 with optimum strength and a coating 32 with optimum bond integrity. The coating 32 is applied to the front face 18 of the seat 16 along the radius 50 of the seat 16 along axis A. The gun 34 points a beam 45 initially at the outer rim 25 of the seat 16 on a point on axis A, and then moves the beam 45 to apply coating 32 from the outer rim 25 of the seat 16 to the inner rim 24 of the seat 16. Beam 45 remains perpendicular to Plane A at all times. Once the gun 34 reaches the bore 20, it reverses course and retraces its path along A to apply coating 32 from the bore 20 of the seat 16 to the outer rim 25 of the seat 16. As shown, the beam 45 contacts the seat 16 normal to the front face 18.

Referring now to FIG. 5, the seat 16 is rotated about axis B while coating 32 is applied to the front face 18 of the seat 16 back and forth between bore 20 and outer rim 25. Obtaining a constant coating 32 thickness can be achieved by timing seat 16 rotation and the gun 34 emissions rate. When the gun 34 sprays coating 32 near the bore 20, some overspray may enter the bore 20 but it is kept minimal by perpendicular path of the beam 45 to plane A. Moreover, the minimal overspray does not significantly attach itself as coating 32 to the inner wall 22 of the bore 20.

Enlarged for clarity in FIG. 6, depicted in a side sectional view is a closed valve 20 with its gate 26 wedged by fluid pressure (represented by arrows) against a seat 16. The fluid pressure bows the gate 26 in its middle concentrating force along an interface 21 between the front face 18 and the bore wall 22. The bowing is exaggerated in FIG. 6. Present coating processes leave a reduced thickness feathered end 33 at the interface 21. Thus hardfacing 32 along the interface 21 is vulnerable to fracturing due to the concentrated stress combined with the decreased thickness hardface coating at the feathered end 33.

### SUMMARY OF INVENTION

Disclosed herein is a method of treating a valve seat having a bore, a seat face, and a chamfered edge joining the bore and seat face. In one example the method includes forming a counter bore from the seat face into the bore that defines a recess, and directing a metal coating spray stream at chamfered edge, so that a metal coating is applied on the chamfered edge, the seat face, and into the recess.

The present disclosure also include a valve that includes a valve body, an axial passage formed through the body, a valve gate having an aperture selectively registerable with the passage, an annular valve seat having a lateral side in contact with the valve gate and a bore registered with the passage, a chamfered edge on the valve seat spanning from a seat face into the bore, and a metal coating on the seat side, the chamfered surface, and along the bore wall past the chamfered edge.

### BRIEF DESCRIPTION OF THE DRAWINGS

FIG. 1 is a sectional view of a typical gate valve according to the prior art with the gate in an open position.

FIG. 2 is a sectional view of the gate valve of FIG. 1 with the gate in a closed position.

FIG. 3 is an enlarged view of the downstream side of the gate valve of FIG. 1 with a prior art coating applied to the top surface of the valve seat.

FIG. 4 is a side view of a thermal spray gun and robotic arm for applying coating to a valve seat of the gate valve of FIG. 1 in a prior art method.

FIG. 5 is a top view of a valve seat of the gate valve of FIG. 3.

FIG. 6 is an enlarged side view of the valve seat of the gate valve of FIG. 3.

FIG. 7 provides a side view of a thermal spray gun and robotic arm for applying coating to a valve seat of a gate valve according to an embodiment of the present disclosure.

FIG. 8 is an enlarged side view of the valve seat of a gate valve as coating is being applied according to an embodiment of the present disclosure.

FIG. 9 schematically illustrates a side sectional view of a valve treated as disclosed herein included with a production tree with a wireline through the valve.

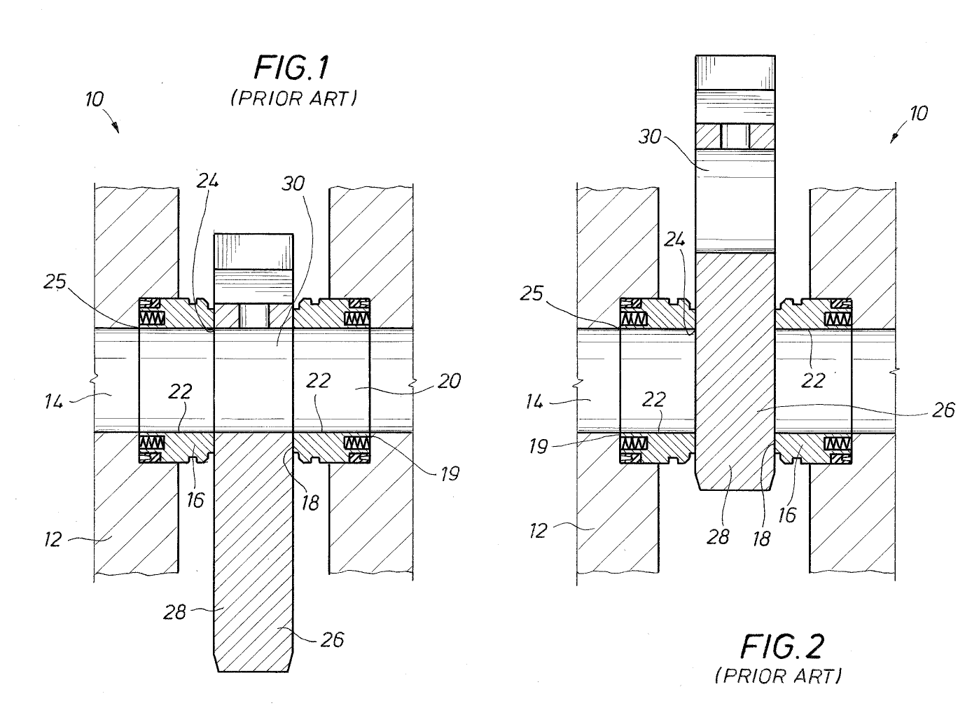

### DETAILED DESCRIPTION OF INVENTION

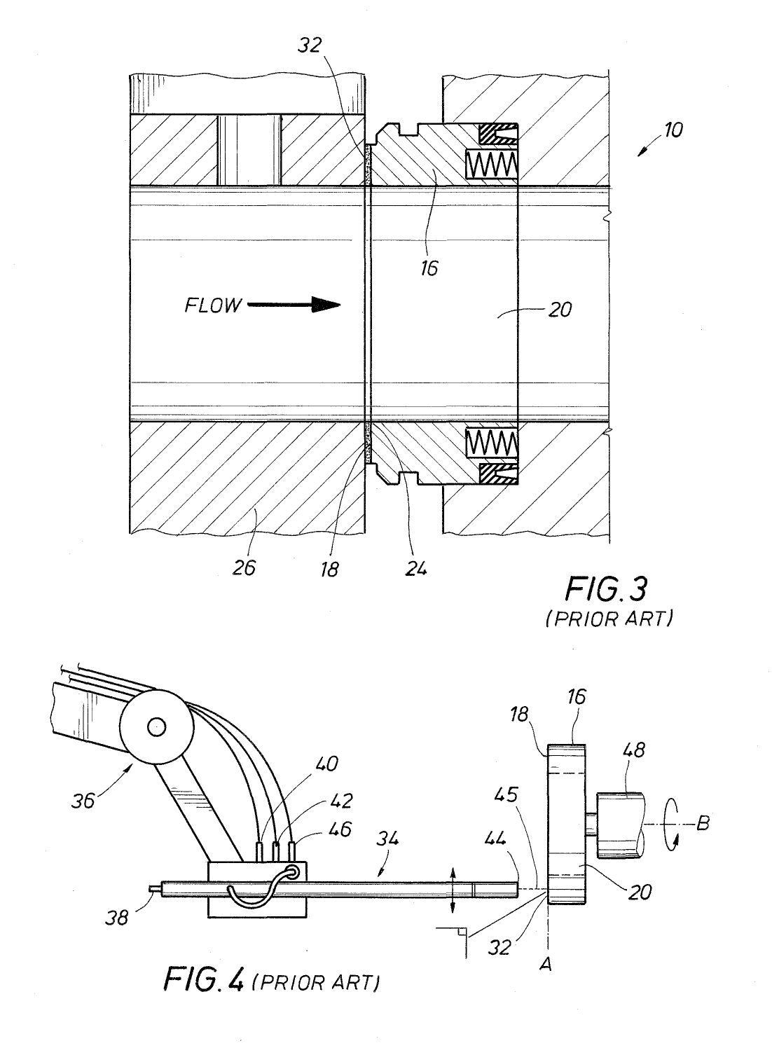

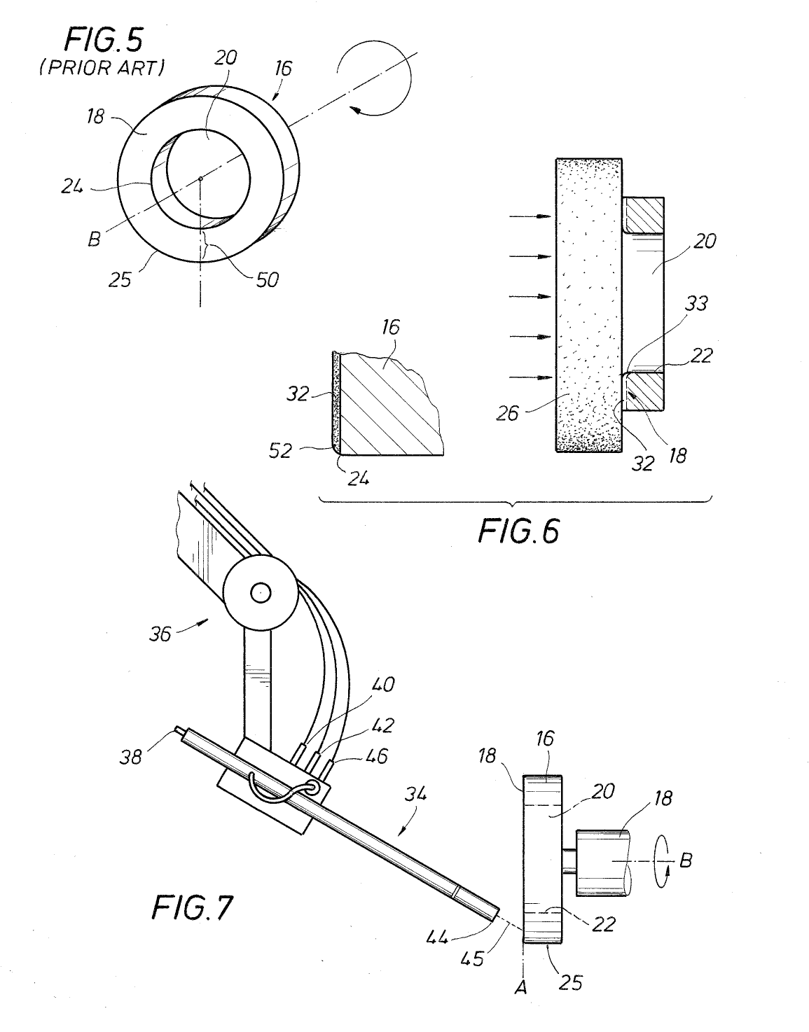

Disclosed herein is a process for treating a downhole component. In an example the component parts may also be treated. The thermal spray gun 34 (FIG. 4) orientation can be advantageously changed during the coating process to apply a coating 32 having a uniform composition and thickness that bonds to the article being treated, including curved surfaces on the article. In one example, a valve seat 16 can be treated by coating one of its lateral faces, i.e. inner or outer face 18, 19, as well as the bore inner wall 22 of the valve seat 16 (FIG. 3).

Referring now to FIG. 7, depicted in a side view is an example of a thermal spray gun 34 coating a valve portion. In the example illustrated, the beam 45 is angled oblique, rather than normal, to the plane A containing the inner face 18. A controller 37, shown in communication with the arm 36, can be included and programmed to control the robotic arm 36. The arm 36 is shown tilting the gun 34 with respect to the plane A as the beam 45 is directed at the seat 16 from the nozzle 44. The arm 36 can manipulate the gun 34 so that the nozzle 44 moves back and forth between the seat 16 outer rim and its bore 20 without changing the oblique angle to the plane A. This can be accomplished by maintaining the gun 34 tilt constant while moving it along the path. Alternatively, the controller 37 may swivel the gun 34 so its tilt angle changes as the nozzle 44 moves along a path. Coating 32 can be applied directly along the seat outer rim 25, the bore inner wall 22, and/or other areas of the seat 16. Optionally, the robotic arm 36 and spray gun 34 can be held stationary and instead, the base 48 securing the seat 16 may be tilted. In an alternative embodiment, the process may be used to provide a coating 32 to other components of the valve 10, for example, certain areas of the solid portion 28 of the gate 26.

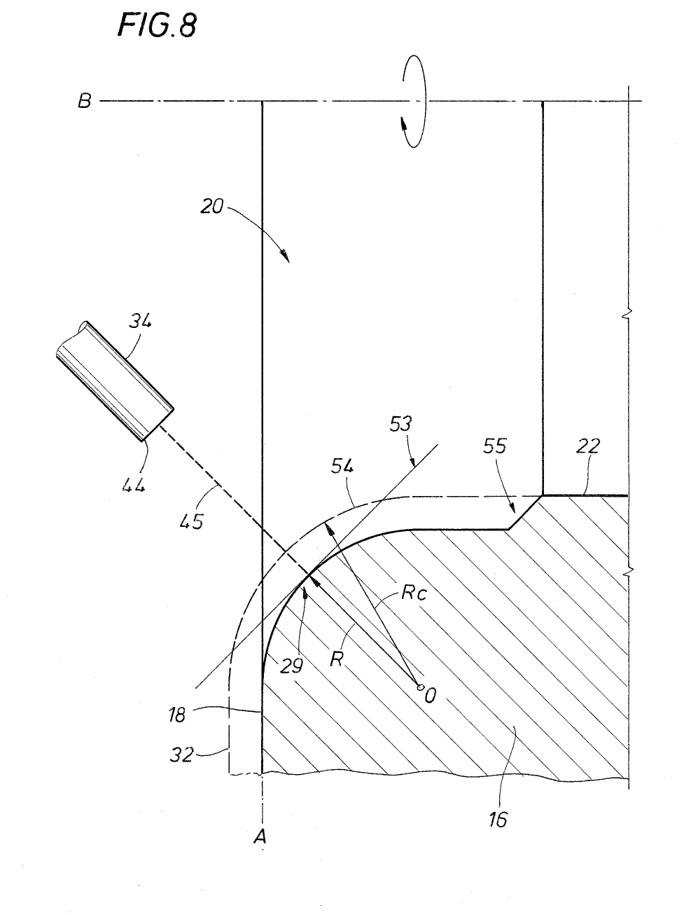

An enlarged view of the coating process of FIG. 7 is shown in a partial sectional side view in FIG. 8. In this example coating 32 is being applied along the boundary 27 between the front face 18 and the bore inner wall 22 where the boundary 27 is on a chamfered edge 29. The chamfered edge 29 includes a curved surface on its outer periphery with a radius R. In the example of FIG. 8, the beam 45 is oriented substantially normal to the chamfered edge 29 at and around the boundary 27. For the purposes of discussion herein, substantially normal to the chamfered edge 29 (including any other curved surface) can mean substantially perpendicular to a tangent line 53 shown where a curved surface is being contacted by the beam 45. When normal to the line 53, the beam 45 may also coincide with the line representing the surface radius R and thus may also point at the origin 0 of the radius R. In one example of use, the boundary 27 may be roughly at the mid-point of the chamfered edge 29. In this example, material being deposited on the chamfered edge 29 at the boundary 27 flows respectively along the front face 18 and towards the bore inner wall 22 to form the coating 32.

In another example of use, the coating process includes adjusting the beam 45 angle (either stepwise or continuously) with respect to the plane A so that the beam 45 remains normal to the chamfered edge 29 at or around the boundary 27, irrespective of where on its curved surface the beam 45 contacts the chamfered edge 29. Thus the orientation of the gun 34 can change as it directs the beam 45 on the chamfered edge 29 along both sides of the boundary 27 between the bore wall 22 and inner surface 18. The orientation change can be performed manually or by the controller.

In the valve 10 embodiment of FIG. 8, a counter bore 54 is provided at an end of the bore 20 adjacent the face 18. A transition 55 on the bore wall 22 defines an end of the counter bore 54. The transition 55 is shown disposed where the bore wall 22 is cylindrical and no longer tapered or conical. The coating 32 of hardfacing (shown in dashed outline) applied to the seat 16 extends to the transition 55, having an outer surface shown generally coplanar with the bore wall 22. Strategically locating the transition 55 a distance inward from the plane A provides a sufficient space to receive the hardfacing without it flowing onto the bore inner wall 22 and protruding into the bore 20.

After being applied, the coating 32 may be ground to provide a curved surface with a radius R_{C}. Optionally, the radius R_{C} can extend from the same origin O as the curved surface radius R. Grinding can also smooth the surface and so that the coating 32 has a uniform desired thickness and contact stress capacity for maximum resistance and sealing capability. As illustrated in FIG. 8, the coating 32 thickness is substantially the same along the front face 18 and the counter bore 54.

The application of coating 32 using a spray gun 34 with multiple degrees of movement according to the present invention increases the likelihood that a significant layer of coating 32 of uniform composition, thickness and bond integrity will attach and form along the front face 18. Additionally, any coating 32 that is applied along the counter bore 54 will provide added support for the section of the coating 32 at the curved surface along the wall 22 and face 18 boundary that is tapered off and has reduced thickness and integrity. Thus valves treated with the present method can withstand greater loading and more loading cycles.

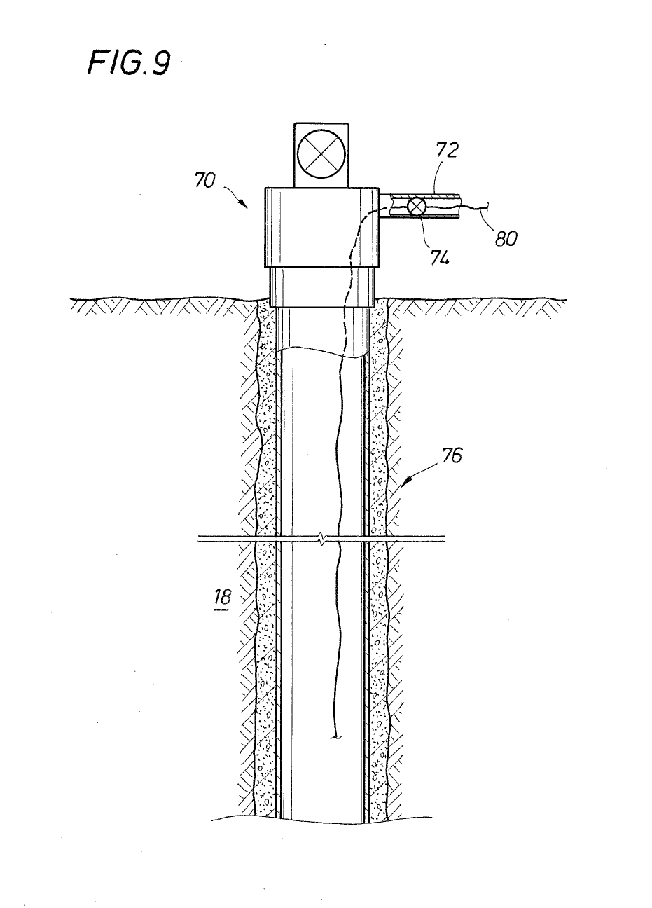

Shown in a schematic view in FIG. 9 is an example of a valve 74 with components, such as a valve gate, coated as described above. The valve 74 is disposed in a line 72 attached to a wellhead assembly 70. The wellhead assembly 70, which can be subsea or on land, is disposed over a well 76 bored through a formation 78. A wireline 80 is inserted through the line 72 and valve 74. The coating on the valve gate and valve seat increases their strength and cutting ability so the valve 74 can be closed onto and more easily sever the wireline 80 (including slickline, and/or tubing) with less susceptibility to damage than untreated valves.

The method described herein can coat a surface or object using a thermal spray or cold spray process, including any other method or technique for applying and/or depositing material onto a surface. Additionally, a vapor gas deposition process can be employed with the present method. In an example, the seat 16 is heated to high temperature in a vapor chamber and controlled amounts of tungsten and carbon gases released into the chamber. The gases contact the seat 16 and form a thin layer of coating 32 on the surface of the seat 16. Since no spraying is involved, the coating thickness will be substantially uniform on the front face 18, inner wall 22, and the chamfered edge 29 along where the face 18 and wall 22 join. The coating 32 can then be ground to a desired thickness.

The present method described herein, therefore, is well adapted to carry out and attain the ends and advantages mentioned, as well as others inherent therein. While a presently preferred embodiment has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A method of treating a valve seat having a bore, a seat face, and a chamfered edge joining the bore and seat face, the method comprising:
a. forming a counter bore from the seat face into the bore that defines a recess; and
b. directing a metal coating spray stream at chamfered edge, so that a metal coating is applied on the chamfered edge, the seat face, and into the recess.

2. The method of claim 1, further comprising moving the stream between an outer rim of the valve seat to the bore to apply the metal coating to the seat face.

3. The method of claim 1, further comprising directing the metal coating spray stream at about the chamfered edge midpoint so that a portion of the coating deposited by the spray stream flows from the midpoint into the recess and another portion of the coating deposited by the spray stream flows from the midpoint to the seat face.

4. The method of claim 3, further comprising coating along a region extending past the chamfered edge.

5. The method of claim 1, wherein the metal coating spray stream comprises a thermal spray process.

6. The method of claim 1, further comprising forming the metal coating spray stream in a metal spray gun and orienting the spray gun with a robotic system.

7. The method of claim 1, further comprising angling the metal coating spray stream oblique to a planar surface to apply a coating to the planar surface.

8. The method of claim 1, further comprising applying the metal coating spray stream to a valve gate, providing the valve gate and valve seat into a valve, disposing the valve within a production tree, and actuating the valve gate to shear a wireline between the valve gate and valve seat.

9. A method of treating a valve comprising:
directing a metal coating spray stream along a line substantially normal to a first location on a curved surface of the valve; and
contacting the first location on the curved surface of the valve with the metal coating spray stream, so that a metal coating is deposited on the valve.

10. A valve comprising:
a valve body;
an axial passage formed through the body;
a valve gate having an aperture selectively registerable with the passage;
an annular valve seat having a lateral side in contact with the valve gate and a bore registered with the passage;
a chamfered edge on the valve seat spanning from a seat face into the bore; and
a metal coating on the seat side, the chamfered surface, and along the bore wall past the chamfered edge.

11. The valve of claim 10 further comprising a counter bore extending from the seat face coaxially into the bore to define a recess.

12. The valve of claim 11, further comprising coating provided in the recess.

13. The valve of claim 10, wherein the coating is substantially uniform in thickness along the seat face, over the chamfered edge, and in the bore.

14. The valve of claim 10, wherein the valve member is selected from the list consisting of a gate, a ball, a globe, and a needle.
